(19) United States
(12) Patent Application Publication
(10) Pub. No.: US 2026/0146727 A1
(43) Pub. Date: May 28, 2026

(54) LIGHT MODULE FOR MOTOR VEHICLE HEADLIGHT

(71) Applicant: VALEO VISION, Bobigny (FR)

(72) Inventors: Laurent MUTHULAR, Bobigny (FR); Jean-Marc GRESSOT, Bobigny (FR)

(73) Assignee: VALEO VISION, Bobigny (FR)

(21) Appl. No.: 19/121,672

(22) PCT Filed: Oct. 18, 2023
(86) PCT No.: PCT/EP2023/079044

§ 371 Date: Apr. 16, 2025

(30) Foreign Application Priority Data
Oct. 18, 2022 (FR) 2210770

(51) Int. Cl. F21S 45/70; F21S 41/29

(52) U.S. Cl. CPC F21S 45/70; F21S 41/265; F21S 41/295; F21S 41/43; F21S 41/55

(57) ABSTRACT

Light module for a headlight of a motor vehicle. The light module includes a plurality of sub-modules, each sub-module producing a light sub-beam, an optical projection unit includes at least one projection lens configured to project at least one of the light sub-beams, and a separator configured to be fixed on the optical projection unit and to separate at least two sub-beams specific to different sub-modules.

### TECHNICAL FIELD

The invention relates to a luminous module for a headlamp of an automotive vehicle, and to a headlamp comprising said module. The invention also relates to a vehicle equipped with a headlamp according to the invention.

### BACKGROUND OF THE INVENTION

Automotive vehicles are conventionally equipped with headlamps, in particular front headlamps, or headlights, intended to illuminate the road in front of the vehicle at night or under low light conditions. A headlamp comprises at least one luminous module composed of a light source. A projecting optical unit comprising at least one projecting lens is mounted in the module to guide at least one light beam generated by the light source in a suitable manner onto the roadway.

Particularly, the same module may comprise a plurality of sub-modules. Each sub-module comprises at least one light source, which is specific thereto and which interacts with the projecting optical unit of the luminous module, and in particular with the projecting lens. Such sub-modules may advantageously have distinct lighting functions and/or uses.

In order to prevent leakage of light between sub-modules and to provide each of the sub-modules in question with a suitable illuminated appearance, it is known to place a separator within the module. Such a separator conventionally comprises a plurality of walls, at least some of said walls being configured to separate light beams generated by adjacent sub-modules. Such a separator is conventionally placed on components of the module such as its housing or on a heat sink. However, the performance provided by such a separator is unsatisfactory, leakage of light being observed between sub-modules.

Furthermore, such separators may adversely affect the esthetic appearance of the headlamp, in particular by allowing components located inside the headlamp to be seen, by reflection for example.

### SUMMARY OF THE INVENTION

The present invention falls within this context and aims to provide a luminous module comprising a plurality of sub-modules delivering optimized lighting, without leakage of light between sub-modules. Another objective of the invention is to provide a luminous module having an attractive esthetic appearance when it is switched off.

The invention relates to a luminous module for a headlamp of an automotive vehicle, characterized in that it comprises:
a plurality of sub-modules, each sub-module comprising at least one light source configured to produce a sub-beam of light;
a projecting optical unit comprising at least one peripheral edge and one projecting region, the projecting region being configured to project the sub-beams of light, and comprising at least one projecting lens borne by the at least one peripheral edge, the projecting lens being configured to project at least one of the sub-beams of light;
a separator fastened to the at least one peripheral edge of the projecting optical unit and comprising at least one intermediate wall configured to separate at least two sub-beams of light specific to distinct sub-modules.

The separator can be fastened only to the projecting optical unit. The separator is thus joined to the rest of the luminous module only via the projecting optical unit. In other words, the separator is fastened to the projecting optical unit, thus forming an “independent” assembly that may be handled as a single component, then this “independent” assembly is fastened to one or more other parts of the luminous module only via the projecting optical unit, i.e. only the projecting optical unit will be fastened to one or more other parts of the luminous module. For example, the projecting optical unit may then be fastened at least partly to a heat sink of the luminous module.

The separator may make contact only with the projecting optical unit, and in particular only with the at least one peripheral edge of the projecting optical unit. As the separator is joined to the rest of the luminous module via the projecting optical unit, it is not necessary for the separator to make contact with another part of the luminous module.

The projecting optical unit comprises at least two peripheral edges, which in particular lie opposite each other, at least one of the peripheral edges comprising at least one member for fastening the separator, the separator comprising at least one fastening element configured to interact with the at least one fastening member of the optical unit.

The separator may lie essentially in a volume bounded by the at least one peripheral edge and the projecting region of the projecting optical unit. By “essentially lie”, what is meant is that at least 50%, or even 75%, of the separator lies in such a volume so as to decrease the bulk generated. Particularly, at least 80%, or even 90% or 100% of the separator may lie in said volume. In particular, when the projecting optical unit comprises a plurality of peripheral edges, the separator lies mainly between these peripheral edges.

In other words, the projecting optical unit surrounds the separator. The at least one peripheral edge and the projecting region create a recess in which the separator is arranged. This arrangement makes it possible to minimize the bulk of the luminous module, since it thus avoids the separator being arranged around the projecting optical unit.

The separator may comprise at least one flange configured to press and/or abut against the at least one peripheral edge of the optical unit.

The separator may be fastened to the projecting optical unit by clip-fastening. In particular, the separator may comprise at least one fastening element of the type that clip-fastens and/or guides fastening of the separator to the projecting optical unit. When the separator is fastened only to the projecting optical unit, it is thus possible to fasten the separator to the projecting optical unit by clip-fastening, and to avoid using fastening screws to fasten the separator to the rest of the luminous module. Specifically, as the separator makes contact with no other part of the luminous module, it does not need to withstand any stress, and the clip allows a precise position of the separator with respect to the projecting optical unit to be guaranteed. In addition, clip-fastening the separator avoids the use of fastening screws to fasten the separator, this allowing the bulk of the luminous module to be decreased.

The projecting region, and in particular the at least one projecting lens, may have an entrance face turned toward at least one of the light sources, the at least one intermediate wall being arranged so as to lie at a non-zero distance from the entrance face, said distance being less than or equal to 2 mm, in particular less than or equal to 1 mm, or even less than or equal to 0.5 mm.

The separator may be made:
of a plastic, such as polycarbonate, polypropylene and/or polyamide; and/or
of a material having a black color; and/or
of a material of matte appearance.

The projecting region of the optical unit may comprise a plurality of projecting lenses, each projecting lens being specific to one sub-module of the plurality of sub-modules.

Optionally, at least one of the sub-modules may comprise a collector comprising a reflective surface configured to reflect light rays emitted by the light source specific to said sub-module so as to form the sub-beam of light and the at least one projecting lens, comprised in the projecting optical unit, said projecting lens being configured to form an image of the reflective surface of the collector.

The invention also relates to a headlamp for an automotive vehicle, which headlamp comprises a luminous module according to the invention.

Lastly, the invention relates to an automotive vehicle comprising a headlamp as described above.

### BRIEF DESCRIPTION OF DRAWINGS

Further details, features and advantages will become more clearly apparent on reading the detailed description given below by way of non-limiting indication and with reference to the various examples of embodiment illustrated in the following figures:

FIG. 1 is a schematic view of one example of embodiment of a vehicle comprising a headlamp comprising a luminous module.

FIG. 2 is a representation in perspective of one example of embodiment of the luminous module according to the invention.

FIG. 3 is a schematic representation in cross section of the luminous module according to the invention.

FIG. 4 is a schematic representation in cross section of the luminous module according to the invention.

FIG. 5 is a schematic representation in perspective of an assembly formed by an optical unit and a separator of the luminous module.

FIG. 6 is a schematic representation in perspective of the assembly formed by the optical unit and the separator when the latter are separated.

FIG. 7 is a schematic representation in cross section of the assembly formed by the optical unit and the separator of the luminous module.

FIG. 8 is a schematic representation in cross section of the assembly formed by the optical unit and the separator of the luminous module.

### DETAILED DESCRIPTION OF THE INVENTION

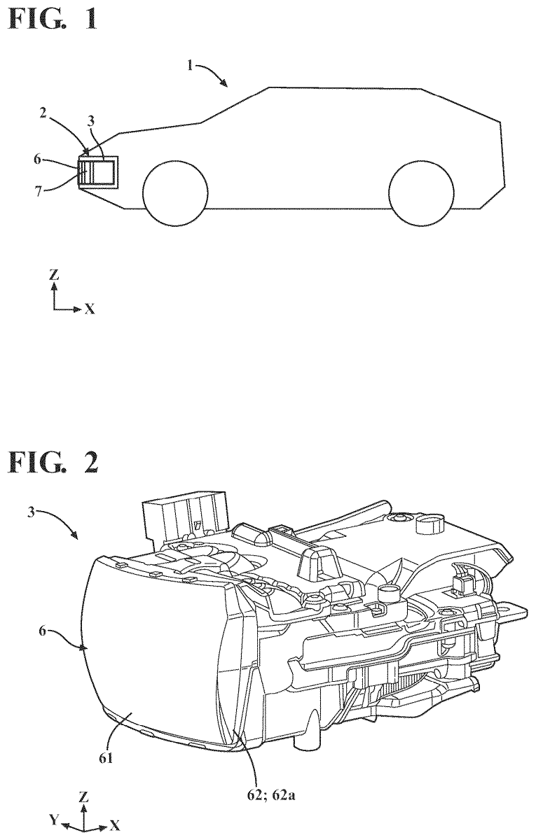

FIG. 1 schematically illustrates an automotive vehicle 1 equipped with a headlamp 2. FIGS. 2 to 4 show one example of embodiment of a luminous module 3 according to the invention for such an automotive-vehicle headlamp 2. In the present case and non-limitingly, the headlamp 2 in question is a front headlamp 2.

By convention, in the following description, the direction in which an automotive vehicle 1 moves when moving in a straight line is defined as being the longitudinal direction X. The forward direction corresponds to the direction in which the automotive vehicle 1 conventionally moves along the longitudinal direction and is opposite to the rearward direction. The direction perpendicular to the longitudinal direction and situated in a plane parallel to the ground is referred to as the transverse direction Y. The direction perpendicular to the directions X and Y, in other words orthogonal to the ground on which the vehicle 1 is standing, is referred to as the vertical direction Z. A direct coordinate system XYZ, which has been shown in the figures requiring it, is thus defined.

Furthermore, the terms “first” and “second” are intended to distinguish between similar components and not to establish a hierarchy of said components.

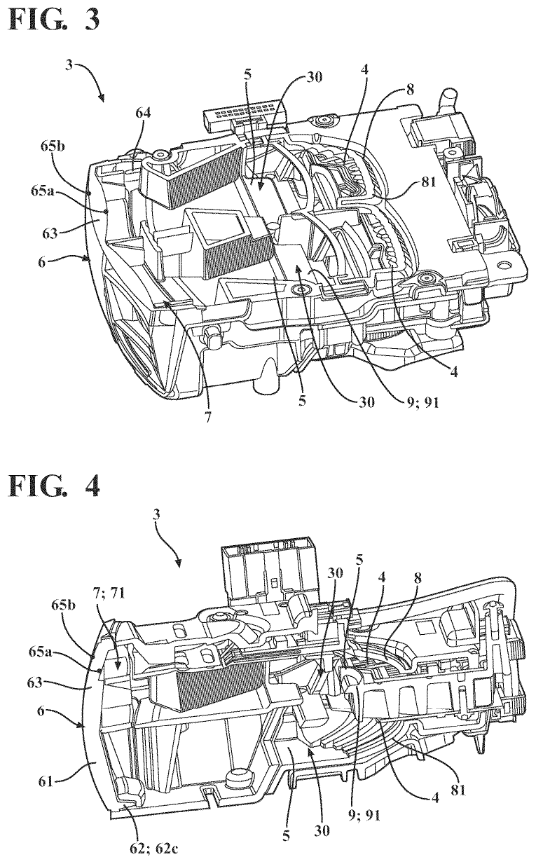

Generally, as illustrated in FIG. 3 or FIG. 4, the luminous module 3 comprises a plurality of sub-modules 30. Each sub-module comprises at least one light source 4 configured to produce a sub-beam of light. Each sub-module 30 lies at least partly in an optical cavity 5 of the luminous module 3, which is specific to it. What is meant by “optical cavity” is a volume comprised in a housing or an external structure bounding the luminous module 3, in which the sub-module 30 in question, and in particular at least the at least one light source 4 specific to said sub-module 30, at least partly lies.

As explained further below, the sub-beams specific to the sub-modules 30 may be configured to be superposed and/or juxtaposed. Also, the sub-beams are preferably selectively activatable. The overall light beam projected onto the road thus results from the superposition and/or juxtaposition of the sub-beams, and may, for example, be adapted to traffic conditions by virtue of independent activation and deactivation of each sub-beam.

The light source 4 is advantageously a semiconductor light source, and in particular a light-emitting diode. Advantageously, a luminous sub-module 30 may comprise a plurality of selectively activatable light sources 4.

The luminous module 3 further comprises a projecting optical unit 6. Generally, the optical unit 6 comprises a projecting region 61 configured to project the sub-beams of light produced by the luminous sub-modules 30 toward a roadway on which the vehicle 1 is being driven, and at least one peripheral edge 62 joined to the projecting region 61. The projecting region 61 comprises at least one projecting lens 63 so that the at least one projecting lens 63 is directly or indirectly borne by the at least one peripheral edge 62. The projecting lens 63 is configured to project at least one sub-beam of light toward the roadway.

The at least one peripheral edge 62 at least partly extends transversely to the projecting region 61, and in particular to the at least one projecting lens 63. It is configured to interact with a front portion of the luminous module 3, the optical unit 6 thereby equipping the front of said module. For example, the at least one peripheral edge 62 may comprise at least one attaching means 64, such as a rail, peg or elastically deformable clip, configured to interact with the housing of the module.

According to a first example of embodiment (not shown) the projecting region 61 is formed by the projecting lens 63. The projecting lens 63 is then common to the plurality of luminous sub-modules 30. The optical unit 6 then comprises a single projecting lens 63 configured to project the various sub-beams specific to the various sub-modules 30. The common projecting lens 63 has a generally curved horizontal profile and entrance and exit faces. At least one segment of the common projecting lens 63 extends longitudinally facing each optical cavity 5 accommodating one of the sub-modules 30 so as to project the sub-beams specific to said sub-modules 30, all the various segments being inscribed in a whole forming the common projecting lens 63.

Alternatively, as may be seen in FIG. 6, the various sub-modules 30 may each be associated with a projecting lens 63 that is specific to it. The luminous module 3 then comprises a plurality of juxtaposed projecting lenses 63 that are joined so as to form the projecting region 61 of the projecting optical unit 6. Similarly to what was described above, the projecting region 61 has a generally curved horizontal profile, an entrance face 65a, which is turned toward the at least one light source 4, and an exit face 65b, which is turned toward the exterior environment of the luminous module 3. In particular, the projecting region 61 of the optical unit 6 comprises an exit face 65b that is inscribed in a smooth shape, which is cambered or curved toward the exterior environment of the luminous module 3. What is meant by “smooth” is differentiable at any point, or in other words devoid of protruding or re-entrant ridges.

The entrance face 65a of the projecting optical unit 6 is then formed by a combination of the internal faces of the various projecting lenses 63 juxtaposed to form the projecting region 61. Such an entrance face 65a may be at least partly continuous or, alternatively, at least some of the projecting lenses 63 may have an internal face that is curved or cambered toward the at least one light source 4, the entrance face 65a of the optical unit 6 then comprising successive undulations corresponding to the internal faces of said projecting lenses 63.

The luminous module 3 according to the invention further comprises a separator 7 configured to be fastened to the at least one peripheral edge 62 of the projecting optical unit 6. The separator 7 is thus configured to lie, within the luminous module 3 and in the longitudinal direction X, between the projecting region 61 (in particular the at least one projecting lens 63 of the optical unit 6) and the light sources 4 specific to various sub-modules 30. The separator 7 comprises at least one intermediate wall 71 configured to at least partly separate at least two sub-beams specific to distinct sub-modules 30. Particularly, such a separator 7 is configured to separate two sub-beams specific to distinct sub-modules 30 in the projecting optical unit 6, i.e. within a volume bounded by the at least one peripheral edge 62 and the projecting region 61 of the projecting optical unit 6.

The separator 7 makes it possible to avoid leakage of light between the sub-beams of distinct sub-modules 30 within the luminous module 3, in particular before the sub-beams reach the projecting optical unit 6. The separator thus prevents certain light rays comprised in the sub-beam of light produced by a sub-module 30 in question from reaching a segment of the projecting region 61 of the projecting optical unit 6 intended to receive the sub-beam of light of another luminous sub-module 30, for example another segment of the projecting lens 63 specific to another luminous sub-module 30 or a projecting lens 63 specific to another luminous sub-module 30. In other words, said separator 7 ensures that the light intended to form a sub-beam does not illuminate a region on the road intended to be illuminated solely by one or more other sub-beams. Thus, the projected sub-beams illuminate only a predetermined region on the roadway.

The separator 7 is configured to be fastened to the rest of the luminous module, and in particular to the housing of the luminous module 3, solely via the projecting optical unit 6. The separator 7 is not fastened directly to the housing of the luminous module 3. In other words, the separator does not make contact with the rest of the luminous module 3, and in particular with the housing. The projecting optical unit 6 and the separator 7 thus form an assembly that is “independent” of the rest of the luminous module 3, i.e. once assembled they form an assembly that may be handled as a single component and separated from the rest of the luminous module 3, from the housing thereof for example.

The separator 7 may thus be positioned right next to the projecting region 61 of the projecting optical unit 6, i.e. to the at least one projecting lens 63, this making it possible to minimize leakage of light and the number of stray rays passing from one sub-module 30 to another, in particular in the optical unit 6. Fastening the separator 7 directly to the optical unit 6 also advantageously allows handling and assembly of the luminous module 3 to be simplified. It also makes it possible to minimize the chain of dimensions between the separator 7 and the projecting optical unit 6.

Generally and preferably, the separator 7 comprises a frame 72 joined to the at least one intermediate wall 71. The frame 72 comprises at least one peripheral wall 73. The peripheral wall 73 may be a lateral peripheral wall 73a, an upper peripheral wall 73b or a lower peripheral wall 73c, as described further below. In particular, according to one preferred example of embodiment, the separator 7 is fastened to the optical unit 6 via the frame 72. The frame 72 may be open, i.e. one or more peripheral walls 73 are inscribed in an outline that is not continuous and not closed, or the frame 72 may be closed.

In particular, the separator 7 may be dimensioned and fastened so that the frame 72 and the at least one intermediate wall 71 essentially lie in the volume bounded by the optical unit 6, i.e. bounded by the at least one peripheral edge 62 and the projecting region 61. What is meant by “essentially” is that at least 50%, or even 75%, of the separator 7 lies in such a volume so as to decrease the bulk generated. Particularly, at least 80%, or even 90% or 100% of the separator 7 may lie in said volume.

Preferably, all or some of the frame 72 and of the at least one intermediate wall 71 form one piece. The separator 7 is in particular made of a plastic, such as polycarbonate (PC), polypropylene (PP) and/or polyamide (PA) or any other rigid plastic.

In addition or alternatively, the separator 7 is preferably made of a material having a black color and/or of a material of matte appearance. Such features aim in particular to improve the esthetic appearance of the luminous module 3, and in particular the switched-off appearance of the latter. Specifically, such a separator 7 makes it harder or even impossible to see the various components with which the interior of the module is equipped, and in particular the components arranged in the volume bounded by the housing of the module. Said components are in particular arranged toward the rear half, in the longitudinal direction X, of the luminous module 3 and may be the light sources 4, a printed circuit board (PCB) configured to control at least one light source 4, a radiator or even an element for reflecting a sub-beam arranged inside the module. In this way, when the module is switched off, light from outside the luminous module 3 that reaches the projecting optical unit 6 is absorbed, at least in part, by the separator 7, this making it possible to prevent it from illuminating the interior of said module.

The separator 7 thus has a dual purpose and simultaneously minimizes leakage of light between sub-modules 30 and improves the visual appearance of the luminous module 3.

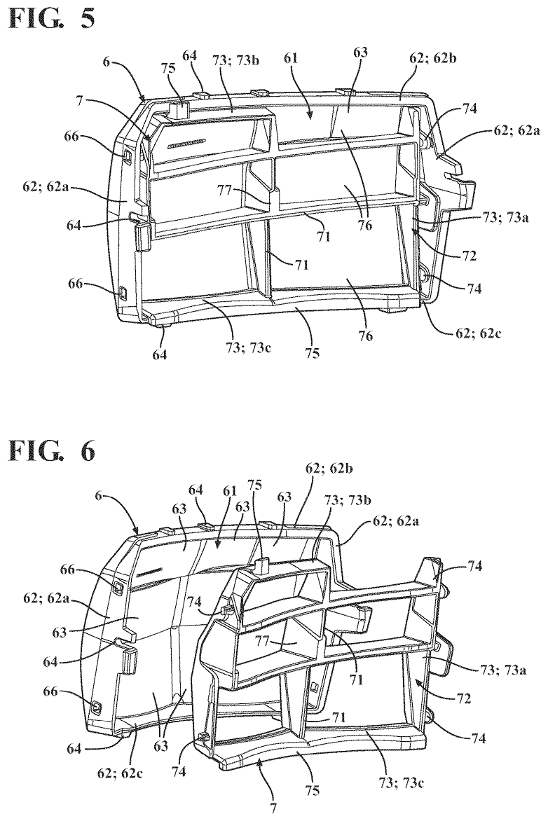

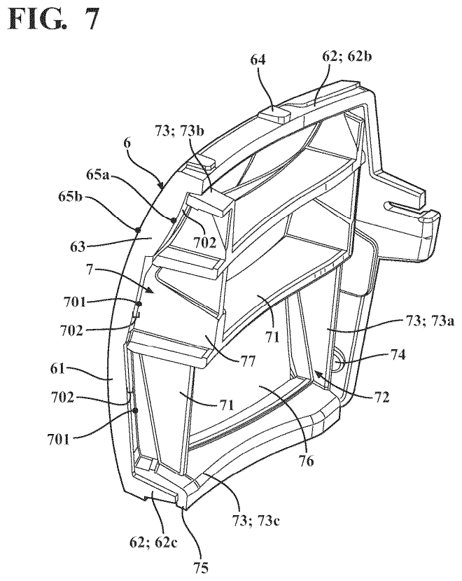

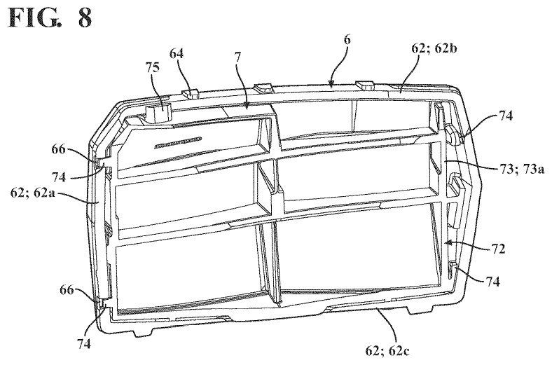

FIG. 5, FIG. 6, FIG. 7, and FIG. 8 illustrate particular examples of embodiment of the optical unit 6 and the separator 7 and their interaction to form an assembly to be joined to the housing of the luminous module 3.

As illustrated, the projecting optical unit 6 may comprise, in one particular but preferred manner, at least two peripheral edges 62. In particular, such peripheral edges 62 may be opposite. Said edges may thus be lateral peripheral edges 62a or upper and lower peripheral edges 62b, 62c. Alternatively, the peripheral edges 62 in question may be adjacent edges.

At least one of said peripheral edges 62 comprises at least one member 66 for fastening the separator 7. Particularly, as illustrated, the same peripheral edge 62 may comprise a plurality of distinct fastening members 66. Non-limitingly, the fastening member 66 may take the form of an orifice, a clip or a peg. The fastening member 66 is comprised in the optical unit 6, i.e. it is neither removable, nor added.

In combination, the separator 7 then comprises at least one fastening element 74 configured to interact with the at least one fastening member 66 of the optical unit 6. Such a fastening element 74 may in particular be arranged in one of the peripheral walls 73 comprised in the frame 72 of the separator 7. According to one alternative (not shown), the at least one fastening element may be borne by the at least one intermediate wall 71. The fastening element 74 has a shape complementary to the shape of the fastening member 66, and it may also be an orifice, a clip or a peg.

In the illustrated example, a first lateral peripheral edge 62a comprises two orifices. Each of said orifices is configured to receive a fastening element 74 of the clip or peg type comprised in a first lateral peripheral wall 73a of the frame 72 of the separator 7. Moreover, a second lateral peripheral edge 62a of the optical unit 6, opposite the first lateral peripheral edge 62a, also comprises two openings each configured to receive one fastening element 74, for example of the guiding-element type, comprised in a second lateral peripheral wall 73 of the frame 72 of the separator 7, opposite the first lateral peripheral wall 73. The use of fastening elements 74 of the clip-fastening and/or guiding type, comprised in the separator and not added, advantageously makes it possible, unlike screws, to decrease the dimensions of the separator 7 and, by extension, of the optical unit 6. It will be understood that the illustrated example is completely non-limiting and that the number, position and type of fastening member(s) and fastening element(s) may be modified. It will also be understood that the type of fastening employed may be inverted between the fastening element 74 and the fastening member 66.

More particularly, in the illustrated example of embodiment, the projecting optical unit 6 may comprise at least three peripheral edges 62 as described above.

The separator 7 may further comprise at least one flange 75 configured to press and/or abut against one of the peripheral edges 62 of the optical unit.

The flange 75 is configured to extend transversely, and in particular orthogonally, to the peripheral edge 62 facing which it lies when the separator 7 is mounted on the optical unit 6. The separator 7 may thus comprise a plurality of peripheral walls 73, at least one of said peripheral walls 73 comprising the aforementioned flange 75. Moreover, at least one of the peripheral walls 73 comprises the at least one fastening element 74. Preferably, the flange 75 and the at least one fastening element 74 are comprised in distinct peripheral walls of the frame 72 of the separator 7. Alternatively, the flange 75 and the at least one fastening element 74 may be comprised in the same peripheral wall 73.

In the illustrated example, the first lateral peripheral wall 73a and the second lateral peripheral wall 73a comprise fastening elements in a manner similar to what was described above. The lower peripheral wall 73c and the upper peripheral wall 73b, which connect the lateral peripheral walls 73a to each other, each comprise one example of a flange 75 of a different shape and size. For example, in the case of the lower peripheral 73c, the flange 75 is configured to press and/or abut against the lower peripheral edge 62c of the optical unit 6 in at least one direction, in particular in the longitudinal X and/or vertical Z direction.

In the various examples mentioned above, the frame 72 of the separator 7 may thus comprise a greater or lesser number of peripheral walls 73. Increasing the number of peripheral walls 73 advantageously allows the separator 7 to be better fastened to the projecting optical unit 6 as it allows the number of regions of contact with the optical unit 6 to be increased and/or allows the number of fastening elements 74 to be increased and/or said fastening elements 74 to be distributed over the frame 72. Moreover, increasing the number of peripheral walls 74 may contribute to improving the esthetic appearance of the luminous module 3, as described above.

Particularly, each of the peripheral walls 74 in question may extend over all or some of a dimension defined in the direction of extension of said wall. For example, as illustrated in FIG. 5 and FIG. 6, the separator 7 comprises an upper peripheral wall 73b extending only over some of a width of the separator 7, defined in the transverse direction Y for example. Particularly, said upper peripheral wall 73 is joined to the first lateral peripheral wall 73a and not to the second. Such an aspect advantageously makes it possible to increase the projection area available to a given segment of the common projecting lens 63 or to a given projecting lens 63, by decreasing the number of peripheral and/or intermediate walls of the separator 7 in a given location in the optical unit 6. Such an aspect is particularly advantageous in the case of headlamps 2 or luminous modules 3 the optical unit 6 of which has particular irregular shapes, employed for esthetic- or design-related reasons, and liable to result in projection areas of the projecting region 61 having dimensions that vary from one sub-module 30 to another.

It will be understood that, in the illustrated example, such an aspect has non-limitingly been applied to the upper peripheral wall 73b, and that it may be applied to any peripheral wall 73 of the frame 72.

Independently of the number of peripheral walls 73 that it comprises, the frame 72 may thus have the function of fastening the separator 7 to the optical unit 6. The frame 72 of the separator 7 also has the function of bearing the at least one intermediate wall 71 configured to separate, in particular in the projecting optical unit 6, at least two sub-beams specific to distinct sub-modules 30. Conversely, the at least one intermediate wall 71 may have a function of holding at least one of the peripheral walls of the frame 72, in particular when said peripheral wall 73 extends partially along a given dimension of the frame 72 as described above.

As illustrated, the separator 7 may comprise a plurality of intermediate walls 71. The intermediate walls 71 may extend in various directions, for example in the vertical direction Z and/or the transverse direction Y. The combination of a plurality of peripheral and/or intermediate walls of the separator 7 makes it possible, in particular, to define projection cavities 76 specific to at least one of the sub-modules 30. Alternatively or additionally, at least one of the projection cavities 76 may be partially open, it then being partly bounded by one of the peripheral edges 62 of the optical unit 6. In the illustrated example, the assembly formed by the separator 7 and the optical unit defines six projection cavities 76, five of which are closed and bounded by the peripheral and intermediate walls. One of said projection cavities 76 is here open, it being bounded by two of the intermediate walls 71 on the one hand and by the peripheral edges 62 of the optical unit 6 on the other hand. The various projection cavities 76 each face, in the longitudinal direction X, at least one of the sub-modules 30 so as to allow the sub-beam specific to the sub-module in question to be projected. In the illustrated example, the luminous module comprises six sub-modules 30, each of the sub-modules 30 thus emitting the sub-beam of light that is specific to it toward one of the projection cavities 76. Said projection cavities 76 also face at least one projecting lens 63 and/or face at least one segment of the projecting region 61 as described above. For example, as illustrated, the projecting region 61 comprises seven projecting lenses 63, five of them each facing closed projection cavities 76 while the open projection cavity 76 here, non-limitingly, faces two distinct projecting lenses 63.

Preferably, the frame 72 and the at least one intermediate wall 71 form one piece, as described above. Alternatively, at least one intermediate wall 71 may be added and removable. Such an intermediate wall 71 may be fastened to the frame 72 and/or to a distinct intermediate wall 71, for example by clip-fastening.

Optionally, the separator 7 may comprise at least one reinforcement 77 configured to reinforce the connection of at least one of the intermediate walls to the frame 72. For example, a region connecting the intermediate wall 71 in question to the frame 72 and/or to a distinct intermediate wall 71 may have a greater thickness than a segment of this same wall located away from said connecting region.

Preferably, the luminous module 3 is configured so that, when the separator 7 is mounted on the optical unit 6, the separator 7 lies at least partly at a non-zero distance from the entrance face 65a of the projecting region 61, i.e. in particular from the at least one projecting lens 63, of the optical unit 6. The separator 7 particularly comprises an outer face 701, which is turned toward the exterior of the luminous module 3 and which corresponds to a surface in which are inscribed all the faces of the one or more intermediate and peripheral walls turned toward the exterior of the luminous module 3. The assembly formed by the separator 7 and the optical unit 6 is configured so that such an outer face 701 lies at a non-zero distance 702 from the entrance face 65a of the optical unit 6. In particular, the separator 7 is arranged at a distance 702 less than or equal to 2 mm, in particular less than or equal to 1 mm, or even less than or equal to 0.5 mm. Particularly, at least the at least one intermediate wall 71 is arranged at a distance 702 of less than or equal to 2 mm, in particular less than or equal to 1 mm, or even less than or equal to 0.5 mm. The interaction between the separator 7 and the optical unit 6 thus preferably occurs in distinct regions of the outer face 701 of the separator 7. It for example occurs on lateral faces of the frame 72 turned toward the optical unit 6, and in particular on the peripheral edges of the optical unit 6, and/or on a rear portion of the separator 7, which portion is turned toward the at least one light source 4, as described with reference to the flange 75. Such an aspect in particular aims to limit transfer of vibrations between the separator 7 and the optical unit 6 and to decrease wear of the separator 7 as a result of friction resulting from such vibrations and scratching of the projecting region 61 and in particular of the at least one projecting lens 63. For example, at least the frame 72 and/or the at least one intermediate wall 71 has such a clearance. Preferably, the frame 72 and the at least one intermediate wall 71 have such a clearance.

Such a clearance may be obtained as a result of the position of the fastening members and elements 66, 74, of the presence of the flange 75, and/or of the shape of the intermediate and/or peripheral walls 71, 73 of the separator 7. For example, the outer face of the separator 7 may have a shape complementary to the shape of the entrance face 65a of the optical unit 6. For example, as illustrated, when the projecting region 61 comprises one or more curved projecting lenses 63 and the entrance face 65a is at least partly curved, one or more of the intermediate walls 71 of the separator 7 may have a shape complementary to such a curvature. The separator 7 may thus be arranged right next to the projecting region 61, so as to limit leakage of light between sub-modules 30.

The luminous module 3, and by extension the headlamp 2, may thus be configured to emit various types of lights, and for example to emit segmented and/or selectively controllable light beams. For example, the luminous module 3 may be used in a first mode, called the “high beam” mode, and/or in a second mode, called the “low beam” or “dipped beam” mode. The “high beam” mode allows the road far in front of the vehicle 1 to be brightly lit. The “low beam” mode provides more limited lighting of the road, but nonetheless offers good visibility without causing other road users discomfort glare. To this end, the headlamp 2 may comprise one or more distinct luminous modules.

For example, a plurality of sub-modules 30 and their sub-beams may be combined to form a dipped or low beam, or a high beam. For example, the sub-beams may form a lighting beam containing a horizontal cutoff with a kink, or a lighting beam having a flat upper horizontal cutoff (commonly called a flat). The sub-beams may also form a complementary high beam allowing a high beam to be formed in combination with a low beam.

It will be understood that, as required, a person skilled in the art will be able to configure the separator 7 and/or the optical unit 6 in order to create various configurations of sub-modules 30 having distinct functions, for example by modifying the number, position and/or shape of the projection cavities 76 and/or of the peripheral and/or intermediate walls 73, 71.

According to one particular example of the luminous module 3 according to the invention, at least one of the sub-modules 30 may advantageously further comprise a collector 8 and at least one of the projecting lenses 63 of the optical unit 6. Alternatively, the sub-module 30 may comprise a segment of the projecting region 61 of the optical unit 6 as described above.

The collector 8 comprises a reflective surface configured to reflect light rays emitted by the light source 4 specific to said sub-module 30 so as to form the sub-beam. The projecting lens 63 is then particularly configured to form an image of the reflective surface of the collector 8.

The collector 8 takes the form of a shell or cap a truncated parabolic profile of which at least partly defines a volume in which the at least one light source 4 lies. The reflective surface is thus arranged on an inner surface of the collector 8, turned toward the at least one light source 4.

In a known manner, the collector 8 is advantageously made of materials exhibiting good heat resistance, for example of glass or of synthetic polymers such as polycarbonate (PC) or polyetherimide (PEI).

Optionally, each collector 8 may be divided into a plurality of sectors 81. In particular, the sub-module 30 may then particularly comprise a plurality of light sources, each being associated with at least one of said sectors 81. The various sectors 81 then have a truncated parabolic profile, each thereof defining a volume in which at least one of the light sources 4 of the sub-module 30 in question is arranged.

Optionally but preferably, said projecting lens 63 has a focal point that is located along an optical axis of the sub-module 30, level with the light source 4 or behind said source. For example, the focal point may be located on the reflective surface of the collector 8. Alternatively, the focal point of said projecting lens 63 may be located behind or in front of the reflective surface, at a distance less than or equal to 10 mm, and preferably less than or equal to 5 mm.

Preferably, all or some of the sub-modules 30 comprise a collector 8 specific thereto. Such a collector 8 lies within the luminous sub-module 30, and in particular within the housing of the luminous module 3. Particularly, the collector 8 lies within the optical cavity 5 specific to the sub-module 30 in question. Where appropriate, a single part may comprise all the collectors 8 of each luminous sub-module 30.

Optionally, the luminous module 3, and particularly at least one of the sub-modules 30, may also comprise at least one heat sink 9, also referred to as a radiator. Such a sink 9 may in particular comprise at least one plate 91 forming a carrier for the at least one light source 4. Advantageously, such a plate 91 may form a carrier common to the plurality of light sources 4 and/or to the collector 8. Moreover, such a heat sink 9 may comprise a plurality of fins. According to one particular embodiment (illustrated), the housing or the external structure bounding the luminous module 3, as described above, may be at least partly formed by the heat sink 9 and/or the collector 8. The optical unit 6 may then be fastened to the heat sink 9.

Thus, the present invention provides a luminous module comprising a plurality of sub-modules and an optical unit and a separator able to form an assembly that is mounted simultaneously within the module so that it advantageously allows optimized illumination, without leakage of light between sub-modules. The luminous module according to the invention may further have an improved esthetic appearance, decreasing visibility of the internal components of the luminous module when the latter is switched off.

The present invention is not however limited to the means and configurations described and illustrated herein, and also extends to any equivalent means or configuration and to any technically functional combination of such means provided that they ultimately perform the functions described and illustrated in the present document.

What is claimed is:

1. A luminous module for a headlamp of an automotive vehicle, comprising:
a plurality of sub-modules, each sub-module including at least one light source configured to produce a sub-beam of light;
a projecting optical unit including at least one peripheral edge and one projecting region, the projecting region being configured to project the sub-beams of light, and including at least one projecting lens borne by the at least one peripheral edge, the projecting lens being configured to project at least one of the sub-beams of light;
a separator fastened to the at least one peripheral edge of the projecting optical unit and including at least one intermediate wall configured to separate at least two sub-beams of light specific to distinct sub-modules.

2. The luminous module as claimed in claim 1, wherein the separator is fastened only to the projecting optical unit.

3. The luminous module as claimed in claim 2, wherein the separator makes contact only with the at least one peripheral edge of the projecting optical unit.

4. The luminous module as claimed in claim 1, wherein the projecting optical unit includes at least two peripheral edges, which in particular lie opposite each other, at least one of the peripheral edges includes at least one fastening member for fastening the separator, the separator includes at least one fastening element configured to interact with the at least one fastening member of the optical unit.

5. The luminous module as claimed in claim 1, wherein the separator lies essentially in a volume bounded by the at least one peripheral edge and the projecting region of the projecting optical unit.

6. The luminous module as claimed in claim 1, wherein the separator includes at least one flange configured to press and/or abut against the at least one peripheral edge of the optical unit.

7. The luminous module as claimed in claim 1, wherein the separator is fastened to the projecting optical unit by clip-fastening.

8. The luminous module as claimed in claim 1, wherein the at least one projecting lens has an entrance face turned toward at least one of the light sources, the at least one intermediate wall being arranged so as to lie at a non-zero distance from the entrance face, the distance being less than or equal to 2 mm.

9. The luminous module as claimed in claim 1, wherein the separator is made:
of a plastic, such as polycarbonate, polypropylene and/or polyamide; and/or
of a material having a black color; and/or
of a material of matte appearance.

10. The luminous module as claimed in claim 1, wherein the projecting region of the optical unit includes a plurality of projecting lenses, each projecting lens being specific to one sub-module of the plurality of sub-modules.

11. The luminous module as claimed in claim 1, wherein at least one of the sub-modules includes a collector with a reflective surface configured to reflect light rays emitted by the light source specific to the sub-module so as to form the sub-beam of light and the at least one projecting lens, included in the projecting optical unit, the projecting lens being configured to form an image of the reflective surface of the collector.

12. A headlamp for an automotive vehicle, comprising a luminous module, the luminous module includes a plurality of sub-modules, each sub-module including at least one light source configured to produce a sub-beam of light, a projecting optical unit including at least one peripheral edge and one projecting region, the projecting region being configured to project the sub-beams of light, and including at least one projecting lens borne by the at least one peripheral edge, the projecting lens being configured to project at least one of the sub-beams of light, and a separator fastened to the at least one peripheral edge of the projecting optical unit and including at least one intermediate wall configured to separate at least two sub-beams of light specific to distinct sub-modules.

13. An automotive vehicle comprising a headlamp, with the headlamp including a luminous module that includes a plurality of sub-modules, each sub-module including at least one light source configured to produce a sub-beam of light, a projecting optical unit including at least one peripheral edge and one projecting region, the projecting region being configured to project the sub-beams of light, and including at least one projecting lens borne by the at least one peripheral edge, the projecting lens being configured to project at least one of the sub-beams of light, and a separator fastened to the at least one peripheral edge of the projecting optical unit and including at least one intermediate wall configured to separate at least two sub-beams of light specific to distinct sub-modules.
